(19) United States
(12) Patent Application Publication
(10) Pub. No.: US 2009/0283600 A1
(43) Pub. Date: Nov. 19, 2009

(54) Automatic detection of an enabled interface of a card reader

(76) Inventors: Wen-Lin Chang, Hsinchu (TW); Satoshi Sugawa, Hsinchu (TW); Chuang Cheng, Hsinchu (TW); Ching-Hu Chen, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/285,187

(22) Filed: Sep. 30, 2008

(30) Foreign Application Priority Data
May 16, 2008 (TW) 097118154

(51) Int. Cl. G06K 7/06

(52) U.S. Cl. 235/441

(57) ABSTRACT

A card reader includes a card interface, and one of the pins of the card interface is selected to decide the state of the card interface. The card reader further includes a control circuit to detect the logic state of the selected pin. If the logic state is a first one, the control circuit decides the card interface is enabled; otherwise, if the logic state is a second one, the control circuit decides the card interface is disabled. In some embodiments, a switch is connected between the selected pin and a power supply or a ground terminal, to be switched by a control signal to enable or disable the card interface.

### FIELD OF THE INVENTION

The present invention is related to a card reader and, more particularly, to an automatic detection method for a card reader to decide whether a card interface thereof is enabled or disabled.

### BACKGROUND OF THE INVENTION

Current card readers generally require additional pins for selectively enabling or disabling card interfaces thereof. FIG. 1 illustrates a method for a conventional card reader 10 to selectively enable or disable the card interfaces thereof, in which the card reader 10 has card interfaces for SD, CF, xD and MS memory cards, and includes an application specific integrated circuit (ASIC) 12 having two pins SW1 and SW2 for the ASIC 12 to decide which card interfaces are enabled/disabled. For example, FIG. 2 shows a logic table for the pins SW1 and SW2 to define the enabled/disabled card interfaces. If the logic state of the pins SW1 and SW2 is “00”, the ASIC 12 will enable only the card interface for SD cards; if the logic sate of the pins SW1 and SW2 is “01”, the ASIC 12 will enable the card interfaces for SD and CF cards; if the logic state of the pins SW1 and SW2 is “10”, the ASIC 12 will enable the card interfaces for SD, CF and xD cards; and if the logic state of the pins SW1 and SW2 is “11”, the ASIC 12 will enable all the card interfaces. However, this method requires additional pins, e.g. SW1 and SW2 in the example of FIG. 1, to decide which card interfaces are enabled or disabled. In addition, such method does not allow free selection among the card interfaces to be enabled/disabled because the selection is determined by the default values, for example the logic table of FIG. 2. Taking the setting in FIG. 2 for example, the ASIC 12 cannot enable only the card interface for MS cards. Rather, the card interfaces for SD, CF, xD and MS cards must all be enabled in order to use MS cards. If it is desired to have a different setting in which the card interface for MS cards can be enabled alone, more pins will be required.

FIG. 3 illustrates another method for a conventional card reader 20 to selectively enable or disable the card interfaces thereof. The card reader 20 includes an EEPROM 22 and an ASIC 24, in which the EEPROM 22 stores various settings for selecting the card interfaces to be enabled or disabled, and the ASIC 24 enables or disables the card interfaces according to the setting chosen from the EEPROM 22. As long as the capacity of the EEPROM 22 is large enough, all possible settings for enabling or disabling the card interfaces can be written into the EEPROM 22 for users to choose freely therefrom. Moreover, even if a desired setting is not found in the EEPROM 22, the EEPROM 22 can be updated by writing new settings thereinto. However, the EEPROM 22 is expensive, and thus the card reader 20 will require more cost.

Therefore, it is desired a low-cost method for a card reader that can freely choose to enable or disable a card interface thereof.

### SUMMARY OF THE INVENTION

An object of the present invention is to provide a method for a card reader to decide whether a card interface thereof is enabled or disabled.

Another object of the present invention is to provide methods for a card reader to enable or disable a card interface thereof.

Yet another object of the present invention is to provide a low cost card reader.

According to the present invention, a pin of a card interface in a card reader is selected to be monitored to decide whether the card interface is enabled or disabled. The card reader includes a control circuit connected to the selected pin, which detects the logic state of the selected pin to decide whether the card interface is enabled or disabled. A switch may be connected between the selected pin and a ground terminal or a power supply, and switched by a control signal to set the card reader to be enabled or disabled.

By detecting the logic state of a selected pin of a card interface in a card reader, the card reader may automatically detect the card interface is enabled or disabled. Since the state of a card interface is decided by monitoring the selected pin of the card interface, the detection of any enabled interface in a card reader will not be limited by any default logic table and will not require any additional components.

### BRIEF DESCRIPTION OF THE DRAWINGS

These and other objects, features and advantages of the present invention will become apparent to those skilled in the art upon consideration of the following description of the preferred embodiments of the present invention taken in conjunction with the accompanying drawings, in which:

FIG. 1 illustrates a method for a conventional card reader to selectively enable or disable the card interfaces thereof;

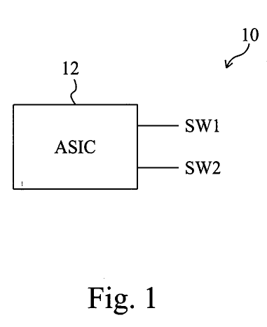

FIG. 2 is a logic table for the pins shown in FIG. 1 to define the enabled/disabled card interfaces;

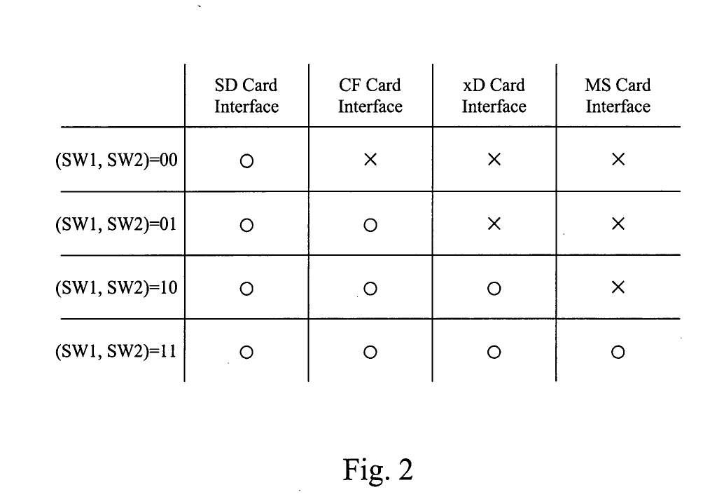

FIG. 3 illustrates another method for a conventional card reader to selectively enable or disable the card interfaces thereof;

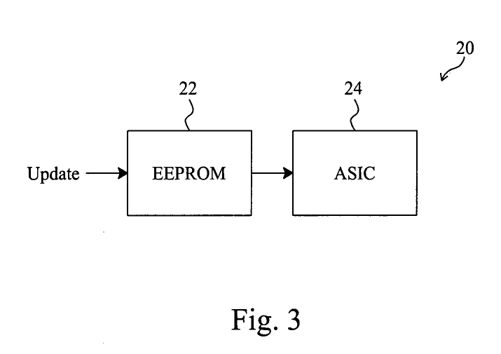

FIG. 4 is a first embodiment according to the present invention;.

FIG. 5 is a second embodiment according to the present invention;

FIG. 6 is a third embodiment according to the present invention; and

FIG. 7 is a fourth embodiment according to the present invention.

### DETAIL DESCRIPTION OF THE INVENTION

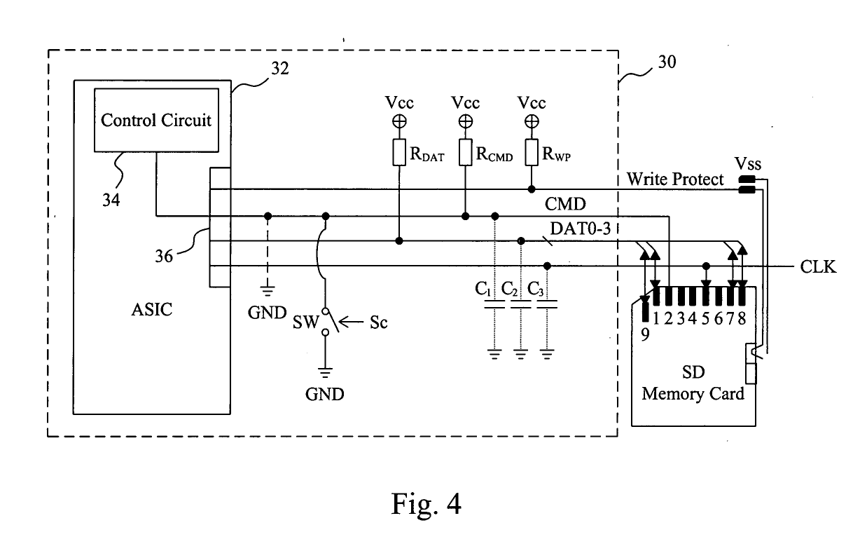

FIG. 4 shows a first embodiment according to the present invention. In a card reader 30, an ASIC 32 includes a control circuit 34 and an SD card interface 36 having a plurality of pins for connecting with an SD memory card. As defined by the SD card specification, the pins of the SD card interface 36 include a pin CMD. In addition to the pull-up resistor R_{CMD} already connected to the pin CMD as defined by the SD card specification, a switch SW is connected between the pin CMD and ground GND to define the state of the SD card interface 36. The on/off state of the switch SW can be determined by either hardware or firmware. During a preset time period, the control circuit 34 will detect the logic state of the pin CMD to decide whether the SD card interface 36 is enabled. If the control signal Sc turns off the switch SW, the pin CMD will have the logic state of HIGH since it is connected to a power supply Vcc via the pull-up resistor R_{CMD}, and the control circuit 34 will decide the SD card interface 36 is enabled. On the contrary, if the switch SW is on, the pin CMD will be grounded through the switch SW, thereby pulling the voltage on the pin CMD to zero. In this case, the pin CMD has the logic state of LOW, and the control circuit 34 will decide the SD card interface 36 is disabled accordingly. In some other embodiments, another pin, for example either one of the pins DAT0-3, may be used in place of the pin CMD for the above illustrated purposes. In some other embodiments, the switch SW according to the present invention and resistors R_{DAT}, R_{CMD} and R_{WP} defined by the SD card specification may be all integrated into the ASIC 32. For the purpose of cost saving, the switch SW may be omitted, so that the pin CMD is connected directly to ground GND when it is desired to disable the SD card interface 36, as shown by the dotted line in FIG. 4.

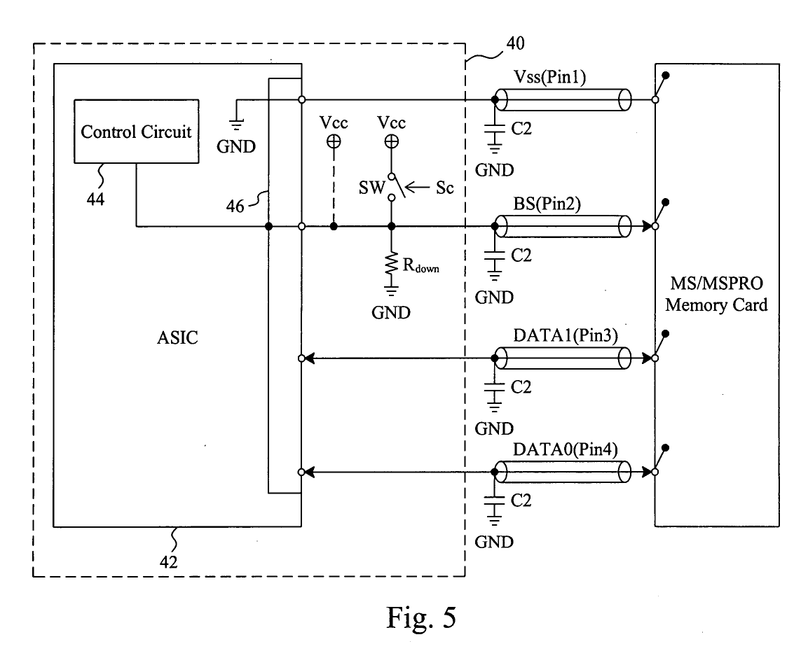

FIG. 5 shows a second embodiment according to the present invention. In a card reader 40, an ASIC 42 includes a control circuit 44 and a MS/MSPRO card interface 46 having a plurality of pins for connecting with MS/MSPRO memory cards. As defined by the MS/MSPRO card specification, the pins of the MS/MSPRO card interface 46 include a pin BS. A switch SW is connected between a power supply Vcc and the pin BS to define the state of the MS/MSPRO card interface 46, and a pull-down resistor R_{down} is connected between the pin BS and ground GND. The on/off state of the switch SW can be determined by either hardware or firmware. During a preset time period, the control circuit 44 will detect the logic state of the pin BS to decide whether the MS/MSPRO card interface 46 is enabled. If the switch SW is off, the pin BS will have the logic state of LOW since it is grounded via the pull-down resistor R_{down}, and the control circuit 44 will decide the MS/MSPRO card interface 46 is enabled. On the contrary, if the switch SW is turned on by the control signal Sc, the pin BS will be connected to the power supply Vcc and thus has the logic state of HIGH. As a result, the control circuit 44 will decide the MS/MSRPO card interface 46 is disabled. Similarly, in some other embodiments, another pin may be used in place of the pin BS for the above illustrated purposes. In some other embodiments, the switch SW and the pull-down resistor R_{down} may be both integrated into the ASIC 42. For the purpose of cost saving, the switch SW may be omitted, so that the pin BS is connected directly to the power supply Vcc when it is desired to disable the MS/MSPRO card interface 46, as shown by the dotted line in FIG. 5.

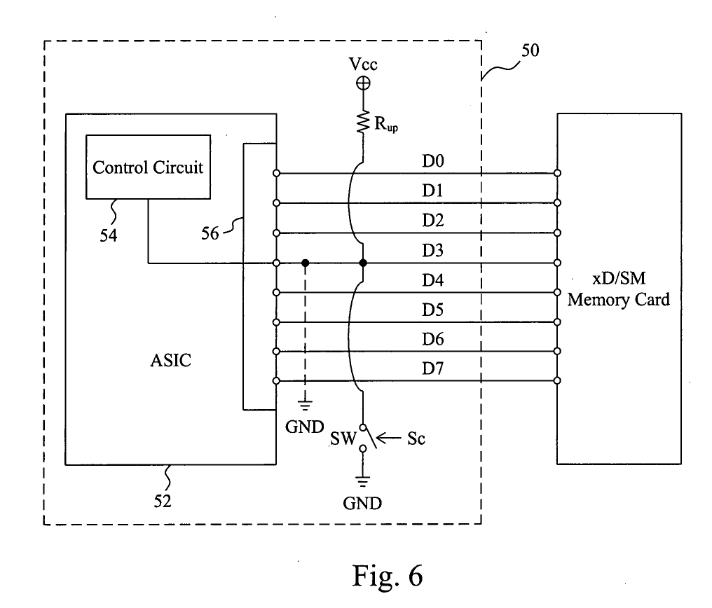

FIG. 6 shows a third embodiment according to the present invention. In a card reader 50, an ASIC 52 includes a control circuit 54 and an xD/SM card interface 56 having a plurality of pins for connecting with xD/SM memory cards. As defined by the xD/SM card specification, the pins of the xD/SM card interface 56 include pins D0-D7 for transmitting and receiving data. To define the state of the xD/SM card interface 36, a switch SW is connected between the pin D3 and ground GND, whose on/off state can be determined by either hardware or firmware, and a pull-up resistor Rᵤₚ is connected between a power supply Vcc and the pin D3. During a preset time period, the control circuit 54 will detect the pin D3 to decide whether the xD/SM card interface 56 is enabled. If the switch SW is turned off by the control signal Sc, the pin D3 will be connected to the power supply Vcc via the pull-up resistor Rᵤₚ and thus have the logic state of HIGH, and the control circuit 54 will decide the xD/SM card interface 56 is enabled. On the contrary, if the switch SW is off, the pin D3 will be grounded and thus have the logic state of LOW, and the control circuit 54 will decide the xD/SM card interface 54 is disabled. In some other embodiments, any one of the pins D0-D2 and D4-D7 may be used in place of the pin D3 for the above illustrated purposes. In some other embodiments, the switch SW and the pull-up resistor Rᵤₚ may be both integrated into the ASIC 52. For the purpose of cost saving, the switch SW may be omitted, so that the pin D3 is connected directly to ground GND when it is desired to disable the xD/SM card interface 54, as shown by the dotted line in FIG. 6.

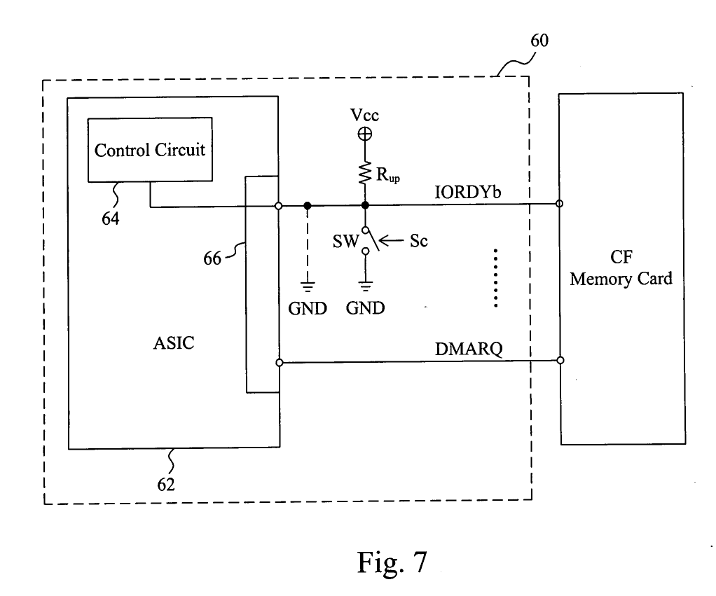

FIG. 7 shows a fourth embodiment according to the present invention. In a card reader 60, an ASIC 62 includes a control circuit 64 and a CF card interface 66 having a plurality of pins for connecting with CF memory cards. The control circuit 64 will monitor the pin IORDYb of the CF card interface 66 to decide whether the CF card interface 66 is enabled. A switch SW is connected between the pin IORDYb and ground GND, whose on/off state can be determined by either hardware or firmware, and a pull-up resistor Rᵤₚ is connected between the pin IORDYb and a power supply Vcc. During a preset time period, the control circuit 64 detects the logic state of the pin IORDYb to decide whether the CF card interface 66 is enabled. If the switch SW is turned off by the control signal Sc, the pin IORDYb is connected to the power supply Vcc via the pull-up resistor Rᵤₚ and thus have the logic state of HIGH. As a result, the control circuit 64 will decide the CF card interface 66 is enabled. On the contrary, if the switch SW is on, the pin IORDYb will be grounded and thus have the logic state of LOW, and the control circuit 64 will decide the CF card interface 66 is disabled. In some other embodiments, another pin, for example the pin DMARQ, may be used in place of the pin IORDYb for the above illustrated purposes. In some embodiments, the switch SW and the pull-up resistor Rᵤₚ may be both integrated into the ASIC 62. For the purpose of cost saving, the switch SW may be omitted, so that the pin IORDYb is connected directly to ground GND when it is desired to disable the CF card interface 66, as shown by the dotted line in FIG. 7.

Under a USB architecture, a firmware has an automatic detection function to decide whether each card interface is enabled, and each time after such detection, the firmware will give a response to a USB host with the existing logical unit numbers. For example, if the SD, CF, xD and MS card interfaces are enabled, the firmware will respond to the USB host that four logical unit numbers exist, such as LUN0, LUN1, LUN2 and LUN3, wherein the logical unit number LUN0 is assigned for the SD card interface, the logical unit number LUN1 is assigned for the CF card interface, the logical unit number LUN2 is assigned for the xD card interface, and the logical unit number LUN3 is assigned for the MS card interface. Otherwise, If the SD, CF and MS card interfaces are enabled and the xD card interface is disabled, the firmware will respond to the USB host that three logical unit numbers exist, such as LUN0, LUN1 and LUN2, which are assigned for the SD card interface, the CF card interface, and the MS card interface, respectively.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. A method for a card reader to decide a card interface thereof is enabled or disabled, the card interface having a plurality of pins for connecting with a memory card, the method comprising the steps of:
detecting a logic state of one of the plurality of pins;
deciding the card interface as being enabled if the logic state is a first state; and
deciding the card interface as being disabled if the logic state is a second state.

2. The method of claim 1, further comprising the step of selecting one of the plurality of pins as the pin to be detected.

3. The method of claim 1, wherein the step of detecting a logic state of one of the plurality of pins is performed during a preset time period.

4. A method for a card reader to enable or disable a card interface thereof, the card interface having a plurality of pins for connecting with a memory card, the card reader including a switch connected between one of the plurality of pins and a ground terminal, the method comprising the steps of:
asserting a control signal in accordance with an instruction; and
turning on the switch by the control signal to disable the card interface.

5. A method for a card reader to enable or disable a card interface thereof, the card interface having a plurality of pins for connecting with a memory card, the method comprising the steps of:
selecting one of the plurality of pins; and
connecting the selected pin to a ground terminal to disable the card interface.

6. A method for a card reader to enable or disable a card interface thereof, the card interface having a plurality of pins for connecting with a memory card, the card reader including a switch connected between one of the plurality of pins and a power supply, the method comprising the steps of:
asserting a control signal in accordance with an instruction; and
turning on the switch by the control signal to disable the card interface.

7. A method for a card reader to enable or disable a card interface thereof, the card interface having a plurality of pins for connecting with a memory card, the method comprising the steps of:
selecting one of the plurality of pins; and
connecting the selected pin to a power supply to disable said card interface.

8. A card reader, comprising:
a card interface having a plurality of pins for connecting with a memory card; and
a control circuit connected to one of the plurality of pins for detecting a logic state thereof and deciding whether the card interface is enabled or disabled in accordance with the logic state.

9. The card reader of claim 8, further comprising a switch connected between the detected pin and a ground terminal for disabling the card interface.

10. The card reader of claim 9, wherein the card interface is a SD interface.

11. The card reader of claim 9, wherein the card interface is a xD interface.

12. The card reader of claim 9, wherein the card interface is a SM interface.

13. The card reader of claim 9, wherein the card interface is a CF card interface.

14. The card reader of claim 8, further comprising a switch connected between the detected pin and a power supply for disabling the card interface.

15. The card reader of claim 14, wherein the card interface is a MS interface or a MSPRO interface.

16. The card reader of claim 8, wherein the control circuit will notify a USB host with the state of the card interface after it decides the card interface is enabled or disabled.

17. The card reader of claim 8, wherein the detected pin is connected to a ground terminal to disable the card interface.

18. The card reader of claim 8, wherein the detected pin is connected to a power supply to disable the card interface.
